(19) United States
(12) Patent Application Publication
(10) Pub. No.: US 2025/0101791 A1
(43) Pub. Date: Mar. 27, 2025

(54) VEHICLE CONTROL DEVICE

(71) Applicant: TOYOTA JIDOSHA KABUSHIKI KAISHA, Toyota-shi (JP)

(72) Inventors: Ken Ohnishi, Toyota-shi (JP); Takashi Yuma, Toyokawa-shi (JP)

(73) Assignee: TOYOTA JIDOSHA KABUSHIKI KAISHA, Toyota-shi (JP)

(21) Appl. No.: 18/661,932

(22) Filed: May 13, 2024

(30) Foreign Application Priority Data
Sep. 25, 2023 (JP) 2023-161742

(51) Int. Cl. E05F 15/70; B60R 16/023; E05F 15/659

(52) U.S. Cl. CPC E05F 15/70; B60R 16/0231; E05F 15/659; E05Y 2900/531

(57) ABSTRACT

The shift control ECU performs shift change control of switching the shift range from the P range to the D range based on a range switching request. When determining that the shift range is the P range based on the shift range state signal representing the shift range inputted from the shift control ECU, the door control ECU executes the opening control of the door based on the opening request for switching the door from the closed state to the open state, and outputs the door state signal representing the open/close state of the door to the shift control ECU. The shift control ECU switches the shift range from the D range to the N range when it is determined that there is a state change that has been switched from the closed state to the open state in the door within the predetermined period after the range switching request.

### CROSS-REFERENCE TO RELATED APPLICATION

This application claims priority to Japanese Patent Application No. 2023-161742 filed on Sep. 25, 2023, incorporated herein by reference in its entirety.

### BACKGROUND

### 1. Technical Field

The disclosure relates to a vehicle control device. A vehicle control device includes a door control electronic control unit (ECU) that controls opening and closing of a door and a shift control ECU that controls switching of a shift range. In the vehicle control device, data are input and output between the door control ECU and the shift control ECU.

### 2. Description of Related Art

There is known a vehicle control device in which opening control for bringing a door into an open state is not executed when the shift range is not a parking (P) range. In this vehicle control device, when the shift range is the P range and the door is in the open state, shift change control for switching the shift range from the P range to a drive range is prohibited and not executed. A vehicle control device of this type is described in Japanese Unexamined Patent Application Publication No. 2022-129422 (JP 2022-129422 A), for example.

### SUMMARY

In some cases, a vehicle control device is divided into a plurality of electronic control units (ECUs), and data are input and output between the ECUs. For example, a vehicle control device is divided into a door control ECU for controlling opening and closing of a door and a shift control ECU for controlling switching of the shift range, and data are input and output between the door control ECU and the shift control ECU. In such a configuration, a predetermined communication time is required to transmit data from one of the door control ECU and the shift control ECU to the other. For this reason, there is a case where shift change control for switching the shift range from the P range to the drive range is executed in spite of a state change in which the door is switched from a closed state to the open state, because of a delay in communication. In this case, there is a possibility that the vehicle is brought into a traveling state against the intention of the driver, although the door is in the open state.

The present disclosure has been made in view of the above circumstances, and an object of the present disclosure is to provide a vehicle control device capable of suppressing a vehicle being brought into a traveling state against the intention of a driver when a door is in an open state.

An aspect of the present disclosure provides
a vehicle control device including: a door control ECU that controls opening and closing of a door; and a shift control ECU that controls switching of a shift range, data being input and output between the door control ECU and the shift control ECU, in which:
(a) the shift control ECU executes shift change control, based on a range switching request for switching the shift range from a parking range to a drive range, to switch the shift range to the drive range indicated by the range switching request;
(b) when it is determined that the shift range is the P range based on a signal representing the shift range and input from the shift control ECU, the door control ECU executes opening control, based on an opening request for switching the door from a closed state to an open state, to switch the door from the closed state to the open state, and outputs a signal representing an open/close state of the door to the shift control ECU; and
(c) the shift control ECU switches the shift range from the drive range to a non-drive range when it is determined that there is a state change in which the door is switched from the closed state to the open state within a predetermined period after the range switching request.

In the vehicle control device according to the present disclosure, (a) the shift control ECU executes shift change control. In the shift change control, the shift range is switched to the drive range indicated by the range switching request based on the range switching request for switching the shift range from the P range to the drive range. (b) The door control ECU occasionally determines that the shift range is the P range based on a signal representing the shift range and input from the shift control ECU. In this case, the door control ECU executes opening control for switching the door from the closed state to the open state based on an opening request for switching the door from the closed state to the open state. In addition, the door control ECU outputs a signal representing the open/close state of the door to the shift control ECU. (c) The shift control ECU occasionally determines that there has been a state change in which the door is switched from the closed state to the open state within a predetermined period after the range switching request. In this case, the shift control ECU switches the shift range from the drive range to the non-drive range. Accordingly, it is possible to suppress the vehicle being brought into a traveling state against the intention of the driver when the door is in the open state.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle in which an electronic control device according to an embodiment of the present disclosure is mounted, and is a functional block diagram illustrating a main part of a control function for various types of control in the vehicle;

FIG. 2 is an exemplary flow chart illustrating the control operation of the electronic control unit shown in FIG. 1; and

FIG. 3 is an example of a time chart when the flowchart shown in FIG. 2 is executed.

### DETAILED DESCRIPTION OF EMBODIMENTS

Hereinafter, an embodiment of the present disclosure will be described in detail with reference to the drawings. Note that, in the embodiments, the drawings are simplified or modified as appropriate, and the dimensional ratios, shapes, and the like of the respective portions are not necessarily drawn accurately.

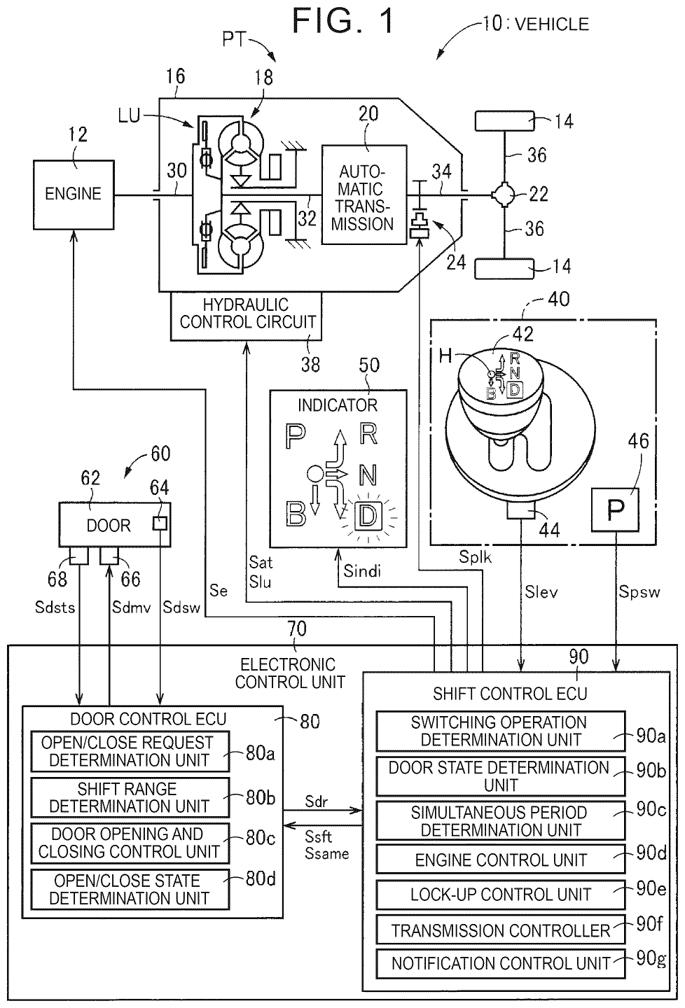

FIG. 1 is a schematic configuration diagram of a vehicle 10 on which an electronic control unit 70 according to an embodiment of the present disclosure is mounted, and is a functional block diagram showing a main part of a control function for various kinds of control in the vehicle 10.

The vehicle 10 is a vehicle 10 on which an occupant other than the driver gets on and off in addition to the driver, and is, for example, a microbus. The vehicle 10 includes an engine 12 that is a power source for traveling. The engine 12 is a well-known internal combustion engine. Vehicle 10 includes, as a well-known configuration, the following power transmission path PT between engine 12 and a pair of drive wheels 14. In the case 16, the engine coupling shaft 30, the torque converter 18, the input shaft 32 which is an input rotation member of the automatic transmission 20, the automatic transmission 20, the output shaft 34 which is an output rotation member of the automatic transmission 20, and the like, which are arranged in this order from the engine 12 side. Further, a differential 22 connected to the output shaft 34, a pair of axles 36 connected to the differential 22, and the like. The case 16 is a non-rotating member attached to the vehicle body. Further, the vehicle 10 includes a hydraulic control circuit 38, a shift operation device 40, an indicator 50, a door opening/closing mechanism 60, and an electronic control unit 70.

The automatic transmission 20 is a well-known automatic transmission, and is, for example, a transmission of a planetary gear type, a constant meshing type, or the like. The output shaft 34 of the automatic transmission 20 is provided with a parking lock mechanism 24, which is a known configuration for mechanically stopping the rotation of the output shaft 34 connected to the pair of drive wheels 14. The parking lock mechanism 24 is switched between a locked state and an unlocked state by an electric actuator.

The hydraulic control circuit 38 supplies the regulated hydraulic pressure to the actuator that operates using the hydraulic oil discharged from the oil pump as the original pressure. The actuator is, for example, an actuator that executes connection/disconnection control of the lock-up clutch LU of the torque converter 18 or an actuator that executes shift control of the automatic transmission 20.

The shift operation device 40 is an operation device for selecting one of a plurality of shift ranges. That is, the shift operation device 40 is an operation device that receives a shift range switching request by being artificially operated. The shift operation device 40 includes, for example, an operator disposed in the vicinity of the driver's seat and selectively operated by the driver to a plurality of operation positions corresponding to the plurality of shift ranges. The shift range represents a power transmission state from the engine 12, which is a power source for traveling, to the pair of drive wheels 14, and includes, for example, an R range, an N range, a D range, and a P range, which will be described later.

The shift operation device 40 employs a so-called shift-by-wire (Shift By Wire) system. The shift operation device 40 includes, for example, a shift lever 42 and a P switch 46. The shift lever 42 and the P switch 46 are both momentary type operators that are returned to the original position (initial position) in a state where no external force is applied. That is, the shift lever 42 and the P switch 46 are operators that are returned to the initial position when not operated by the driver (in other words, auto-return type operators that automatically return to the initial position when the operating force is released).

The operation positions of the shift lever 42 are, for example, operation positions of “H position”, “R position”, “N position”, “D position”, and “B position”. The “H position” is an initial position (home position) of the shift lever 42. Even if the shift lever 42 is operated to an operation position other than the “H position”, if the driver releases the shift lever 42, the shift lever 42 is returned to the “H position” by a mechanical mechanism such as a spring. Even if the shift lever 42 is operated to an operation position other than the “H position”, if there is no external force acting on the shift lever 42, the shift lever 42 is returned to the “H position” by a mechanical mechanism such as a spring. The “R position” is an operation position for selecting an R range that enables the vehicle 10 to travel backward. The “N position” is an operation position for selecting an N range in which power transmission from the engine 12 to the pair of drive wheels 14 is interrupted and is in a neutral state. For example, in the N range, the automatic transmission 20 is in a neutral state. The “D position” is an operation position for selecting a D range that enables the vehicle 10 to travel forward. The “B position” is an operation position for selecting a decelerated forward traveling state in which the engine brake using the engine 12 is easily applied in a state in which the power transmission path PT for forward traveling is formed by the operation to the “D position”. The “B position” is an operation position for selecting a deceleration forward traveling state in which the engine braking effect is obtained more strongly in a state in which the power transmission path PT for forward traveling is formed by the operation to the “D position”.

The P switch 46 is, for example, a momentary push button switch. When the P switch 46 is pushed in by the driver, the power transmission from the engine 12 to the pair of drive wheels 14 is cut off. When the P switch 46 is pushed by the driver, a P range in which the pair of drive wheels 14 are mechanically fixed in a non-rotatable manner is selected. In a state in which the P switch 46 is not pushed in, the P switch 46 is set to its initial position (home position). If the driver releases the P-switch 46 even if the P-switch 46 is depressed, the P-switch 46 is returned to its initial position by a mechanical mechanism such as a spring. The P range and the N range are non-driving ranges, and the R range and the D range are driving ranges.

In response to the P range of the shift range, the automatic transmission 20 is controlled to a P range in which the power transmission state thereof is in a neutral state and the output shaft 34 connected to the pair of drive wheels 14 is mechanically fixed so as not to rotate. In response to the R range of the shift range, the automatic transmission 20 is controlled to an R range in which the power transmission state thereof enables reverse travel. In accordance with the N range of the shift range, the automatic transmission 20 is controlled to the N range in which the power transmission state thereof is set to the neutral state. In accordance with the D range of the shift range, the automatic transmission 20 is controlled to the D range in which the power transmission state thereof enables forward travel.

The indicator 50 is provided at a position that is easy for the driver to see, and displays a shift range (including a P range) that is being selected. The indicator 50 may indicate, for example, an actual power transmission state of the automatic transmission 20. In the shift operation device 40 of the present embodiment, the shift lever 42 and the P switch 46 are returned to the initial position when no external force is applied. Therefore, the driver cannot recognize the selected shift range only by visually recognizing the shift lever 42 and the P switch 46. Therefore, it is useful to provide such an indicator 50.

The door opening/closing mechanism 60 includes a door 62, a door switch 64, and a door opening/closing motor 66. The door 62 is a door provided in the vehicle 10, for example, a door mainly for an occupant to get on and off, and is, for example, a well-known sliding door provided on a side surface of the vehicle body. The door 62 corresponds to a “door” in the present disclosure. The door switch 64 is a switch for requesting opening and closing of the door 62, and is provided in, for example, the door 62. The door opening/closing motor 66 is a motor that slides the door 62 in order to switch the door 62 from one of the open state and the closed state to the other. For example, when the door switch 64 is operated by an occupant and an opening request for switching the door 62 from the closed state to the open state is made, the door opening/closing motor 66 executes an opening control for switching the door 62 from the closed state to the open state. For example, when the door switch 64 is operated by an occupant and a closing request for switching the door 62 from the open state to the closed state is made, the door opening/closing motor 66 executes a closing control for switching the door 62 from the open state to the closed state.

The electronic control unit 70 includes a plurality of ECU that function as a control unit that controls each unit of the vehicles 10. The electronic control unit 70 includes a door control ECU 80 and a shift control ECU 90. The door control ECU 80 is a ECU for controlling opening and closing of the door 62. The shift control ECU 90 is a ECU that controls switching of the shift range. Note that the electronic control unit 70 corresponds to a “control device” in the present disclosure. For example, the door-control ECU 80 and the shift-control ECU 90 in the electronic control unit 70 are each connected to a network that communicates using Controller Area Network (CAN) communication circuitry. This allows the door-control ECU 80 and the shift-control ECU 90 to input and output data to and from each other. The door-control ECU 80 and the shift-control ECU 90 include, for example, a so-called microcomputer including a CPU, RAM, ROM, an input/output interface, and the like. CPU performs various kinds of control of the vehicles 10 by performing signal-processing in accordance with a program stored in ROM in advance while using a temporary storage function of RAM.

Various signals and the like (for example, lever position signal Slev, P switch signal Spsw, and the like) based on the detected values by various sensors and the like (for example, lever position sensor 44, P switch 46, and the like) are inputted to the shift control ECU 90. The shift control ECU 90 receives data from the door control ECU 80 (for example, a door state signal Sdr indicating the actual opening/closing status of the door 62 determined by the door control ECU 80 as described later). From the shift control ECU 90, various command signals are outputted to the respective apparatuses included in the vehicles 10. Each device provided in the vehicle 10 is, for example, an engine 12, a hydraulic control circuit 38, a parking lock mechanism 24, an indicator 50, and the like. Examples of the various command signals are engine control signals Se for controlling the engine 12. Examples of the various command signals are a shift control signal Sat for performing shift control of the automatic transmission 20 via the hydraulic control circuit 38, and a LU control signal Slu for performing connection and disconnection control of the lock-up clutch LU. The various command signals are exemplified by an operation control signal Splk for switching an operation state (a locked state or a released state) of the parking lock mechanism 24. Examples of the various command signals are shift range display signals Sindi for displaying the present shift range.

The door-control ECU 80 is configured to receive various types of signals and the like based on detections by various sensors and the like. Examples of the various sensors include a door switch 64 and a door opening/closing state sensor 68. The various signals and the like are, for example, an opening/closing request signal Sdsw requesting opening/closing of the door 62, and an opening/closing state signal Sdsts indicating whether the door 62 is actually in an open state or a closed state. The door-control ECU 80 receives a shift-control ECU 90. The data is, for example, a shift range status signal Ssft representing the actual shift range determined by the shift control ECU 90, as described below. For example, Ssame indicates that the shift range has been switched and the change in condition at the door 62 has occurred at the same time. From the door control ECU 80, various command signals (for example, a door opening/closing control signal Sdmv for controlling the opening/closing of the door 62, and the like) are outputted to a device (for example, a door opening/closing motor 66, and the like) provided in the vehicle 10.

The door control ECU 80 functionally includes an opening/closing request determination unit 80a, a shift range determination unit 80b, a door opening/closing control unit 80c, and an opening/closing state determination unit 80d.

The opening/closing request determination unit 80a determines whether or not there is a request to open the door 62.

The shift range determination unit 80b determines an actual shift range based on the shift range status signal Ssft inputted from the shift control ECU 90. The determination of the actual shift range is delayed by a predetermined communication period required to transmit data from the shift control ECU 90 to the door control ECU 80.

When the opening/closing request determination unit 80a determines that there is a request to open the door 62 and the shift range determination unit 80b determines that the actual shift range is the P range, the door opening/closing control unit 80c executes the opening control of the door 62. When the opening/closing request determination unit 80a determines that there is a request to open the door 62 and the shift range determination unit 80b determines that the actual shift range is other than the P range, the door opening/closing control unit 80c does not execute the opening control of the door 62. When the opening/closing request determination unit 80a determines that the door 62 is requested to be closed, the door opening/closing control unit 80c executes closing control for switching the door 62 from the open state to the closed state.

The opening/closing state determination unit 80d determines whether the door 62 is actually in a closed state or an open state. The door control ECU 80 outputs the door state signal Sdr to the shift control ECU 90. The door state signal Sdr is a signal representing the actual opening and closing state of the door 62.

The shift control ECU 90 functionally includes a switching operation determination unit 90a, a door state determination unit 90b, a simultaneous period determination unit 90c, an engine control unit 90d, a lock-up control unit 90e, a transmission control unit 90f, and a notification control unit 90g.

The switching operation determination unit 90a determines whether or not a range switching request requesting switching of the shift range is operated by the shift lever 42. For example, the range switching request from the P range to the D range of the shift range is determined based on whether or not the shift lever 42 has been operated from the “H position” to the “D position”. The “D range” switched from the P range corresponds to the “drive range” in the present disclosure.

The door state determination unit 90b determines the actual opening/closing state of the door 62 based on the door state signal Sdr inputted from the door control ECU 80. Further, the door state determination unit 90b determines whether or not there is a state change (hereinafter, simply referred to as “state change”) that has actually been switched from the closed state to the open state by the door 62 based on the door state signal Sdr inputted from the door control ECU 80. The determination of the actual opening/closing state of the door 62 and the determination of the state change in the door 62 are determined by delaying a predetermined communication period required for transmitting data from the door control ECU 80 to the shift control ECU 90.

The simultaneous period determination unit 90c determines whether or not the door state determination unit 90b determines that the state change has occurred in the door 62 within the predetermined period T [ms] from the time point when it is determined that the range switching request from the P range to the D range has been operated by the shift lever 42. The case where there is a state change in the door 62 within the predetermined period T is the same as the case where the change in the shift range and the state change in the door 62 occur at the same time. The predetermined period T is a predetermined period by experiment or design as a communication time required to transmit data from one of the door control ECU 80 and the shift control ECU 90 to the other. For example, the predetermined period T is a certain period Tc [ms] based on a condition in which transmission of data from one of the door control ECU 80 and the shift control ECU 90 to the other is slowest. The condition in which the transmission of the data is the slowest is, for example, a condition in which the communication amount is assumed to be the largest and the transmission of the data is assumed to be the slowest due to the communication load.

The engine control unit 90d controls the engine torque Te [Nm] so as to realize the drive requirement for the vehicles 10. The drive request amount is calculated, for example, by applying the accelerator operation amount θacc and the vehicle speed V [km/h] to the drive request amount map. The drive request amount map is a relationship for determining a drive request amount that has been determined and stored by experiment or design in advance.

The lock-up control unit 90e controls the engagement and disengagement of the lock-up clutch LU of the torque converter 18. The lock-up control unit 90e controls the lock-up clutch LU to be in a released state in a case of a relatively low vehicle speed such as a vehicle start, and controls the lock-up clutch LU to be in an engaged state in a case of a relatively high vehicle speed.

The transmission control unit 90f performs a shift determination of the automatic transmission 20 using, for example, a shift map, and performs shift control as needed. The shift map is a predetermined relationship having a shift line for determining the shift of the automatic transmission 20 on two-dimensional coordinates having, for example, the accelerator operation amount θacc and the vehicle speed V as variables.

When the switching operation determination unit 90a determines that the range switching request from the P range to the D range has been operated by the shift lever 42, the transmission control unit 90f switches the automatic transmission 20 to the D range in which the range switching request has been made. However, when the simultaneous period determination unit 90c determines that the state change has occurred in the door 62 within the predetermined period T, the transmission control unit 90f switches the shift range from the D range to the N range by setting the automatic transmission 20 to the neutral state. The “N range” to be switched corresponds to the “non-driving range” in the present disclosure. When the simultaneous period determination unit 90c determines that the state change has occurred in the door 62 after the lapse of the predetermined period T, the transmission control unit 90f maintains the automatic transmission 20 in the D range in which the range switching is requested.

When the simultaneous period determination unit 90c determines that the state has changed in the door 62 within the predetermined period T, the shift control ECU 90 outputs the simultaneous determination signal Ssame to the door control ECU 80. When the door control ECU 80 receives the simultaneous timing determination signal Ssame from the shift control ECU 90, the door opening/closing control unit 80c stops or interrupts the opening control of the door 62.

In some cases, the simultaneous period determination unit 90c determines that there is a state-change in the doors 62 within the predetermined period T. In this case, the notification control unit 90g causes a buzzer (not shown) to output an alarm sound, that is, to notify the driver that the shift range is switched from the D range to the N range.

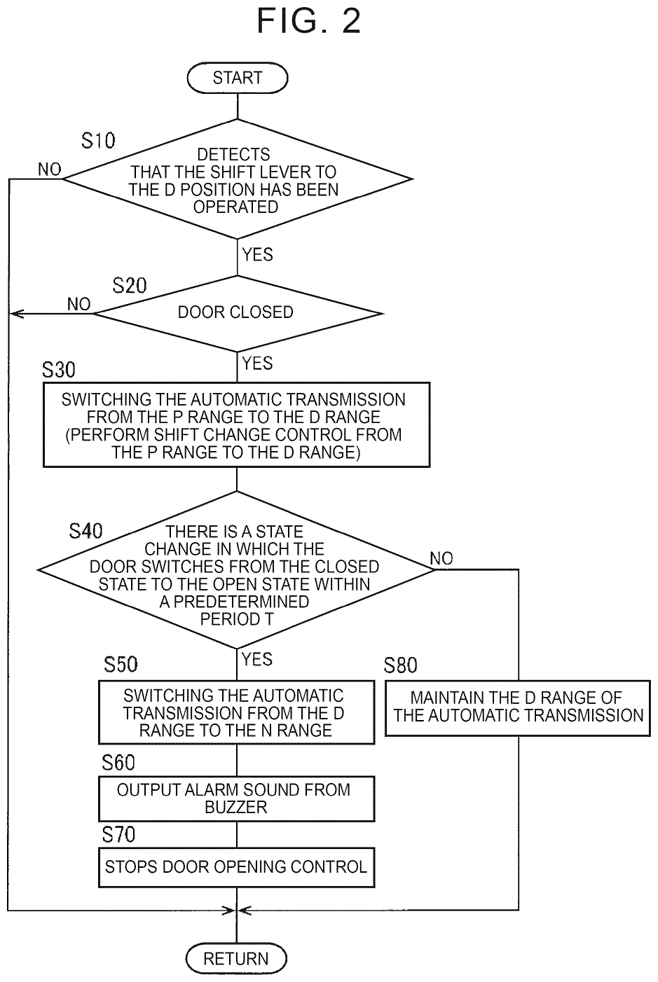

FIG. 2 is an example of a flowchart illustrating a control operation of the electronic control unit 70 illustrated in FIG. 1. The flowchart of FIG. 2 is repeatedly executed when the shift range is the P range. In the flowchart of FIG. 2, an example is shown in which the shift lever 42 is operated from the “H position” to the “D position” in the case where the shift range is the P range.

First, it is determined whether or not the shift lever 42 has been operated from the “H position” to the “D position” in S10 corresponding to the function of the switching operation determination unit 90a (hereinafter, “steps” will be omitted). When the determination of S10 is YES, it is determined whether or not the actual open/close state of the door 62 is the closed state in S20 corresponding to the function of the door state determination unit 90b. When the determination of S20 is YES, the automatic transmission 20 is switched from the P range to the D range in S30 corresponding to the function of the transmission control unit 90f. After S30 is executed, in S40 corresponding to the function of the simultaneous period determination unit 90c, it is determined whether or not a state change has occurred in the door 62 within the predetermined period T, that is, whether or not the shift range switching and the state change at the door 62 have occurred at the same time.

When the determination of S40 is YES, the automatic transmission 20 is switched from the D range to the N range in S50 corresponding to the function of the transmission control unit 90f. After S50 is executed, a warning sound is outputted from the buzzer in S60 corresponding to the function of the notification control unit 90g. After S60 is executed, the opening control of the door 62 is stopped in a S70 corresponding to the function of the door opening/closing control unit 80c.

When the determination of S40 is NO, the D range of the automatic transmission 20 is maintained in S80 corresponding to the function of the transmission control unit 90f.

When S10 determination is NO, when S20 determination is NO, both returns after S70 is executed and after S80 is executed.

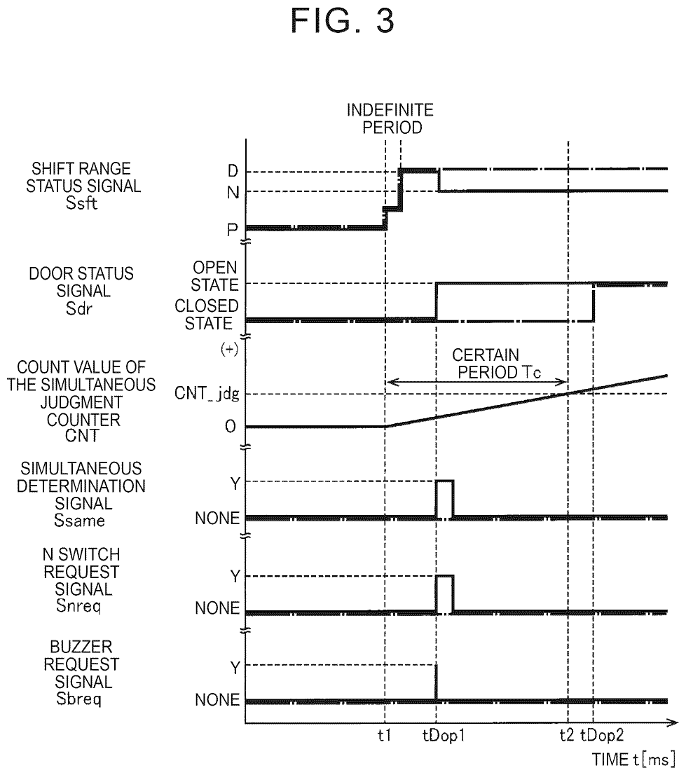

FIG. 3 is an example of a time chart when the flowchart shown in FIG. 2 is executed. In FIG. 3, the abscissa is the time t [ms]. FIG. 3 shows an example of a time chart (solid line) in which the shift range switching and the state change in the door 62 occur at the same time, and an example of a time chart (dashed-dotted line) that does not occur at the same time. The shift range status signal Ssft, the door state signal Sdr, the simultaneous timing determination signal Ssame, the N-switch request signal Snreq, and the buzzer request signal Sbreq shown in FIG. 3 are signals in the shift control ECU 90. That is, the shift range status signal Ssft, the simultaneous timing determination signal Ssame, the N switching request signal Snreq, and the buzzer request signal Sbreq are signals determined or outputted in the shift control ECU 90. The door state signal Sdr is a signal inputted from the door control ECU 80 to the shift control ECU 90, and is delayed by communication.

First, an example of a time chart (solid line) in which switching of a shift range and a state change in the door 62 occur at the same time will be described.

Before the time t1, the following conditions are satisfied. The vehicle 10 is stopped. The shift range status Ssft is “P range”. The door state signal Sdr is “closed”. The count value CNT by the simultaneous timing determination counter is the default value “0”. The simultaneous timing determination Ssame is “none”. The N switching request signal Snreq for requesting switching to the N range based on the simultaneous timing determination signal Ssame is “none”. The buzzer request-signal Sbreq that requires the buzzer to output an alarm sound is “none”.

In the time t1, the shift lever 42 is operated from the “H position” to the “D position” by the driver. As a result, the switching control of the parking lock mechanism 24 from the locked state to the released state is started. When the control of switching the parking lock mechanism 24 to the release state is completed, the shift range state Ssft changes to the “D range”. During the switching control of the parking lock mechanism 24 from the locked state to the released state, the shift range state Ssft is set to “undefined”.

The count value CNT starts counting from the time t1. When the time t2(>t1) is exceeded, the count value CNT exceeds the predetermined determination value CNT_jdg. The predetermined determination value CNT_jdg is a count value determined in advance so that a period between the time t2 and the time t1 becomes a certain period Tc.

At time tDop1(t1<tDop1≤t2) within the certain period Tc, the door state signal Sdr changes from the closed state to the open state. Due to this change, a determination signal in which the simultaneous timing determination signal Ssame is “present” is outputted. It is determined that the door state signal Sdr has changed from the closed state to the open state within the certain period Tc when the count value CNT at the time tDop1 at which the door state signal Sdr has changed from the closed state to the open state is equal to or less than the predetermined determination value CNT_jdg. When the simultaneous timing determination signal Ssame outputs a determination signal of “Yes”, the N switching request signal Snreq outputs a request signal of “Yes”, and accordingly, the automatic transmission 20 is set to the N range and the shift range status signal Ssft is switched to the N range. Further, when the simultaneous determination signal Ssame outputs a determination signal of “Yes”, the buzzer request signal Sbreq outputs a request signal of “Yes”, and an alarm sound is output from the buzzer in response thereto.

Next, an example of a time chart (dashed-dotted line) in which the shift range switching and the state change in the door 62 do not occur at the same time will be described. In the present time chart example, only a portion in which the above-described shift range switching and the state change in the door 62 are different from the time chart example generated at the same time will be described.

In this exemplary time chart, the door state signal Sdr changes from the closed state to the open state at time tDop2(t2<tDop2) after the certain period Te has elapsed. In this change, the count value CNT at the time tDop2 when the door state signal Sdr changes from the closed state to the open state exceeds the predetermined determination value CNT_jdg. Therefore, it is determined that the door state signal Sdr has changed from the closed state to the open state after the lapse of the certain period Tc. Since the state changes in the door 62 after the lapse of the certain period Tc, the simultaneous determination signal Ssame is maintained at “no”, and the N-switch request signal Snreq and the buzzer request signal Sbreq are also maintained at “no”. In response to the N switching request signal Snreq and the buzzer request signal Sbreq being maintained at “no”, the D range of the automatic transmission 20 is maintained and the “D range” of the shift range status signal Ssft is maintained.

According to the present embodiment, (a) the shift control ECU 90 performs shift change control for switching the shift range to the D range in which the range switching request is made, based on the range switching request for switching the shift range from the P range to the D range. (b) The door control ECU 80 may determine that the shift range is the P range based on the shift range status Ssft representing the shift range inputted from the shift control ECU 90. In this case, the opening control of the door 62 is executed based on the opening request for switching the door 62 from the closed state to the open state, and the door state signal Sdr indicating the open/close state of the door 62 is outputted to the shift control ECU 90. (c) The shift control ECU 90 switches the shift range from the D range to the N range when it is determined that there is a state change in the door 62 within the predetermined period T after the range switching request. Accordingly, when the door 62 is in the open state, the vehicle 10 is prevented from being in the traveling state contrary to the intention of the driver.

According to the present embodiment, (a) the door control ECU 80 determines that the shift range is the D range on the basis of the shift range status signal Ssft, and does not execute the opening control. (b) The shift control ECU 90 maintains the shift range in the D range in which the range switching request is made, when it is determined that the state change has occurred in the door 62 after the lapse of the predetermined period T after the range switching request. After the lapse of the predetermined period T after the range switching request, the door control ECU 80 disables the opening control, and thus the door 62 is prohibited from being opened. Therefore, it is considered that the case where the shift control ECU 90 determines that the state has changed in the door 62 after the lapse of the predetermined period T after the range switching request is the case of erroneous determination due to noise or the like. Therefore, excessive suppression of the running state of the vehicle 10 is limited.

According to the present embodiment, the predetermined period T is a certain period Tc based on the condition that the transmission of the data from one of the door control ECU 80 and the shift control ECU 90 to the other is the slowest. When the predetermined period T is set to a certain period Tc, transmissions between the door control ECU 80 and the shift control ECU 90 are reliably performed, and the complexity of the control is suppressed as compared with, for example, when the predetermined time period T is changed according to the communication load condition.

According to the present embodiment, the shift control ECU 90 determines that the condition of the door 62 has changed within the predetermined period T. When the shift range is switched from the D range to the N range, the shift control ECU 90 notifies the driver of the fact that the shift range is switched from the D range to the N range by an alarm sound from the buzzer. As a result, the driver is prompted to perform an operation of avoiding the simultaneous occurrence of the shift range switching and the state change at the door 62.

It should be noted that the above-described embodiments of the present disclosure are examples of the present disclosure, and the present disclosure can be implemented in various modifications and improvements based on the knowledge of a person skilled in the art without departing from the gist thereof.

In the above-described embodiment, the shift control ECU 90 may execute shift change control for switching the shift range from the P range to the D range based on a range switching request for switching from the P range to the D range. In this case, it may be determined that there is a state change in the door 62 within the predetermined period T after the range switching request. In this case, the shift range is switched from the D range to the N range. The present disclosure is not limited to the above-described embodiments. For example, in some cases, shift change control is performed to switch the shift range from the P range to the R range on the basis of a range switching request for switching the shift control ECU 90 from the P range to the R range. In this case, when it is determined that there is a state change in the door 62 within the predetermined period T after the range switching request, the present disclosure is also applicable to a mode in which the shift range is switched from the R range to the N range. In this aspect, the R range corresponds to the “drive range” in the present disclosure.

In the above-described embodiment, the shift control ECU 90 is configured to switch the shift range from the D range to the N range when it is determined that there is a state change in the door 62 within the predetermined period T after the range switching request. For example, the shift control ECU 90 may be switched to the P range instead of the N range. In this aspect, the P range corresponds to the “non-driving range” in the present disclosure.

In the above-described embodiment, the engine 12 is the power source for traveling, but the present disclosure is not limited to this embodiment. For example, the driving power source may be an electric motor.

In the above-described embodiment, switching of the shift range to the non-drive range (N range, P range) is performed in such a manner that the power transmission path PT is shut off in the automatic transmission 20 to be in a neutral condition, but the present disclosure is not limited thereto. For example, the vehicle 10 may be provided with a starting clutch instead of the torque converter 18 in the vehicle configuration of the above-described embodiment. In this case, the switching to the non-driving range is made to be in the neutral state by shutting off the power transmission path PT when the starting clutch is in the released state (=disconnected state). This aspect may be an aspect of the disclosure.

In the above-described embodiment, the notification control unit 90g notifies the driver by outputting an alarm sound from the buzzer, but the present disclosure is not limited to this embodiment. For example, in addition to a mode in which the driver is notified by an audible notification device such as a buzzer, the driver may be notified by a visual notification device such as a display or an alarm lamp.

What is claimed is:

1. A vehicle control device comprising a door control ECU that controls opening and closing of a door; and a shift control ECU that controls switching of a shift range, data being input and output between the door control ECU and the shift control ECU, wherein:
the shift control ECU executes shift change control, based on a range switching request for switching the shift range from a parking range to a drive range, to switch the shift range to the drive range indicated by the range switching request;
when it is determined that the shift range is the P range based on a signal representing the shift range and input from the shift control ECU, the door control ECU executes opening control, based on an opening request for switching the door from a closed state to an open state, to switch the door from the closed state to the open state, and outputs a signal representing an open/close state of the door to the shift control ECU; and
the shift control ECU switches the shift range from the drive range to a non-drive range when it is determined that there is a state change in which the door is switched from the closed state to the open state within a predetermined period after the range switching request.

2. The vehicle control device according to claim 1, wherein:
the door control ECU does not execute the opening control when it is determined that the shift range is the drive range based on a signal representing the shift range; and
the shift control ECU maintains the shift range in the drive range indicated by the range switching request when it is determined that the state change has occurred in the door after lapse of the predetermined period after the range switching request.

3. The vehicle control device according to claim 1, wherein the predetermined period is a certain period determined in advance based on a condition that delays transmission of the data from one of the door control ECU and the shift control ECU to the other most.

4. The vehicle control device according to claim 1, wherein the shift control ECU informs a driver that the shift range has been switched from the drive range to the non-drive range when it is determined that the state change has occurred in the door within the predetermined period and the shift range has been switched from the drive range to the non-drive range.
